(19) United States
(12) Patent Application Publication
(10) Pub. No.: US 2009/0289444 A1
(43) Pub. Date: Nov. 26, 2009

(54) Airbag, system and method for deploying an airbag

(76) Inventor: Ramesh Keshavaraj, Peachtree City, GA (US)

Correspondence Address: Legal Department (M-495), P.O. Box 1926, Spartanburg, SC, 29304, US

(21) Appl. No.: 12/154,050

(22) Filed: May 20, 2008

(51) Int. Cl. B60R 21/26; B60R 22/00

(52) U.S. Cl. 280/736; 701/45

(57) ABSTRACT

An inflatable passenger restraint airbag having an inflatable and transferable gas vent is disclosed. A system and method is provided whereby the force of airbag deployment may be reduced in real time if the airbag strikes an out of position seat occupant. This force reduction is made possible by release of inflation gas at an early stage of deployment through an adjustable gas vent. This gas vent is operable between an open venting position and a closed non-venting position. Whether or not the transfer of the vent occurs in a given deployment situation is determined by the presence or absence of an out of position obstruction in the pathway of the airbag.

### BACKGROUND

Automotive safety restraint airbags have achieved widespread acceptance. Airbags reliably save lives in the event of collision. Airbags may be divided into several types, including frontal impact type airbags and side curtain (rollover) type airbags. Both types of airbags use explosive charges to inflate rapidly a textile to decelerate the passenger.

In normal operation, frontal impact airbags are essentially inflated in only a few milliseconds. By design, frontal impact airbags are typically inflated prior to the time the seated passenger fully impacts the airbag with his or her face and head. Upon impact, the passenger “rides” down on the airbag as the airbag deflates, with gas escaping through conventional holes in the underside of the airbag. Such controlled deflation is designed to occur during impact of the passenger upon the airbag. This mechanism softens the impact to the upper body of the passenger during collision.

In the event of a passenger that is not at the time of collision resting in the normal upright seated position, airbags may not be effective. In some cases of such “out of position” passengers, airbags can be harmful to the occupant. If a passenger is unusually close to the dashboard or airbag deployment point at the time of collision, then the explosion of the airbag into the passenger's head or upper body may cause injury or death. Various designs have been used in an attempt to remedy the “out of position” (“OOP”) passenger situation.

One manner of dealing with the OOP passenger situation uses electronic sensors to sense if a passenger is in the normal seated position at the time of impact. Sensors may be deployed in the seat to determine the location or mass of a person, and whether or not a person is resting on the seat. Other sensors may be used to electronically determine if an object or passenger is located too close to the airbag deployment location at the time of impact. When an OOP passenger is detected, the force of the airbag deployment electronically may be adjusted to reduce the risk of passenger injury. This may occur by reducing or eliminating a portion of the inflation mechanism, thereby reducing the release of the gas charge into the airbag.

One disadvantage of such electronic sensors is that sensors are not always reliable, and they are subject to variability. Furthermore, sensors are subjected to extreme temperatures in the interior of automobiles. Heat and age may damage electronic components. Such sensors may be in the automobile for many years before they are actually activated in airbag deployment. Thus, sensor age may contribute to the failure of the sensors. Electronic sensors typically add significant financial cost to an airbag deployment system.

What is needed in the industry is a reliable and relatively inexpensive system for providing a reduced force airbag deployment in the event of an out of position passenger. This invention is directed to such an airbag, system and method.

### BRIEF DESCRIPTION OF THE DRAWINGS

FIG. 1 shows a passenger in an upright seat-belted position;

FIG. 2 illustrates an airbag deployed in the initial stage of a collision, before the passenger has moved forward into the airbag;

FIG. 3 represents a different set of circumstances as compared to FIGS. 1-2, in which an obstruction of an out of position passenger (OOP) has his or her upper body and head undesirably near the dashboard or steering wheel at the exact time of collision, which results in the airbag undesirably deploying into and striking the head and upper body of the out of position passenger;

FIG. 4 shows an inflatable and transferable vent of the airbag of the invention, in the open venting position, which corresponds to FIG. 3 deployment;

FIG. 5 reveals the transfer of a gas vent from an open venting position to a closed non-venting position, which occurs in the normal unobstructed deployment illustrated in FIGS. 1-2 and 7-8;

FIG. 6 illustrates the final stage of vent transfer where vent is part of the tethering system, resulting in substantial closure of the adjustable gas vent, corresponding to FIGS. 2 and 8;

FIG. 6A illustrates one potential embodiment of the inflatable and transferable vent;

FIG. 6B shows another embodiment of the gas vent;

FIG. 7 illustrates a top view of an early stage deployment similar to that shown in FIG. 2, wherein the leading edge of the unobstructed airbag is applying tension to the tethers, which pulls on the adjustable, inflatable and transferable vents; and

FIG. 8 shows the situation of FIG. 7 at a later point in time, in which the tethers which are part of the inflatable and transferable vents have pulled the gas vents from the exterior side to the interior side of the primary inflatable enclosure, resulting in closure of the gas vents.

FIG. 9A reveals an alternate embodiment of the invention, with an alternate configuration for the inflatable and transferable vent, using a cross sectional view along lines 9A-9A;

FIG. 9B is a top view of the device shown in FIG. 9A;

FIG. 9C is a side perspective view;

FIG. 9D shows the same embodiment in the closed venting configuration;

FIGS. 10A-10E shows yet another alternate embodiment of an inflatable and transferable vent;

FIGS. 11A-E show yet another additional embodiment of the invention with inflatable and transferable vent; and

FIGS. 12A-E show another alternate embodiment of the invention, using a somewhat different configuration of the gas vent 130.

### DESCRIPTION OF THE INVENTION

An inflatable passenger restraint airbag, system, and method for using such an airbag are provided. The airbag includes a primary inflatable enclosure, the primary inflatable enclosure having an interior side and an exterior side. The primary inflatable enclosure includes a mouth opening and a central cavity. The primary inflatable enclosure is adapted for connection to an inflation mechanism at the mouth opening. At least one inflatable and transferable gas vent is connected directly or indirectly to the primary inflatable enclosure. The inflatable gas vent is transferable between an open venting position and a closed non-venting position. A tether is provided, the tether being at least partially located within the central cavity of the primary inflatable enclosure. The tether is connected both to the inflatable gas vent and also to the inflatable enclosure. In one embodiment of the invention, the tether is configured for transfer of the vent from an open venting position to a closed non-venting position. In at least one embodiment, the vent in the open venting position is positioned substantially on the exterior side of the primary inflatable enclosure. In some embodiments, the airbag is provided with two of such gas vents, one on each side. The vent in the closed non-venting position may be positioned substantially on the interior side of the primary inflatable enclosure, in one embodiment of the invention. When the gas vent is in the closed position, there is substantially no gas release from the interior to the exterior of the primary inflatable enclosure, which maximizes the restraint function of the airbag.

A system for adjusting the force of airbag deployment in real time is provided in the application of the invention. The system includes an inflation mechanism capable of producing inflation gas and a primary inflatable enclosure. The primary inflatable enclosure has an interior side and an exterior side. The primary inflatable enclosure has a mouth opening and a central cavity. The primary inflatable enclosure is connected to the inflation mechanism at the mouth opening. At least one inflatable and transferable gas vent is connected to the primary inflatable enclosure, the gas vent being transferable between an open venting position, and a closed non-venting position.

A tether is at least partially located within the central cavity of the primary inflatable enclosure, the tether being connected both to the vent and also to the inflatable enclosure. Upon activation of the inflation mechanism, the amount of inflation of the primary inflatable enclosure depends upon the amount of displacement of the leading edge of the primary inflatable enclosure during inflation. A large displacement (as when there is no OOP passenger or no obstruction) will cause the tether to transfer the inflatable and transferable vent to the closed non-venting position. This facilitates maximum force deployment of the airbag. The maximum inflation of the primary inflation enclosure is facilitated by movement of the adjustable gas vent from an open venting position to a closed non-venting position, the movement being facilitated by tension applied to transfer the vent with the tether that is part of this system.

In some applications during the activation of the inflation mechanism an OOP passenger in undesirable close proximity to the primary inflatable enclosure is contacted by the primary inflatable enclosure at an early stage of inflation. When that occurs, such contact results in minimal displacement forward of the leading edge of the airbag, and therefore results in maintenance of the inflatable and transferable gas vent in the open venting position during the inflation event. This reduces the volume of gas in the primary inflatable enclosure by gas venting through the adjustable gas vent. The force of deployment of the primary inflatable enclosure upon the passenger is reduced in that instance.

In one aspect of the invention, a method for deploying an airbag against a seat occupant is provided. In the method, an inflation mechanism capable of producing inflation gas is provided. A primary inflatable enclosure having an interior side and an exterior side is disclosed. The primary inflatable enclosure has a mouth opening and a central cavity on the interior side. The primary inflatable enclosure is connected to the inflation mechanism at the mouth opening. At least one inflatable vent is provided that is transferable between an open venting position and a closed non-venting position. A tether also is provided, the tether being at least partially located within the central cavity of the primary inflatable enclosure. The tether is connected to the adjustable vent and to the inflatable enclosure and configured for transfer of the adjustable vent. Upon activation of the inflation mechanism, gas is forced into the primary inflatable enclosure. This causes a rapid advancement of the primary inflatable enclosure. If the primary inflatable enclosure encounters an out of position seat occupant, then advancement of the tether is inhibited. In that instance, then the inflatable vent is not transferred, so that the inflatable vent remains in the open venting position. This minimizes the force of deployment of the airbag against an out of position seat occupant.

If the primary inflatable enclosure does not encounter an out of position seat occupant, there is full advancement of the leading edge of the airbag. In that instance, there is full advancement of the tether which is connected to the leading edge of the airbag enclosure. Thus, the tether applies a tension force to the inflatable vent, thereby pulling and transferring the adjustable vent to the closed non-venting position. The inflatable vent is pulled by the advanced tether into a closed non-venting position located substantially on the interior side of the enclosure. This maximizes the deployment of the airbag against a seat occupant.

### DETAILED DESCRIPTION OF THE INVENTION

The details of the invention may be appreciated by reference to the Figures. The Figures are provided for illustration of one or more embodiments of the invention, but it should be recognized that the invention may be practiced in other ways that are not specifically shown or illustrated in the Figures, but such embodiments still are within the spirit and scope of the invention.

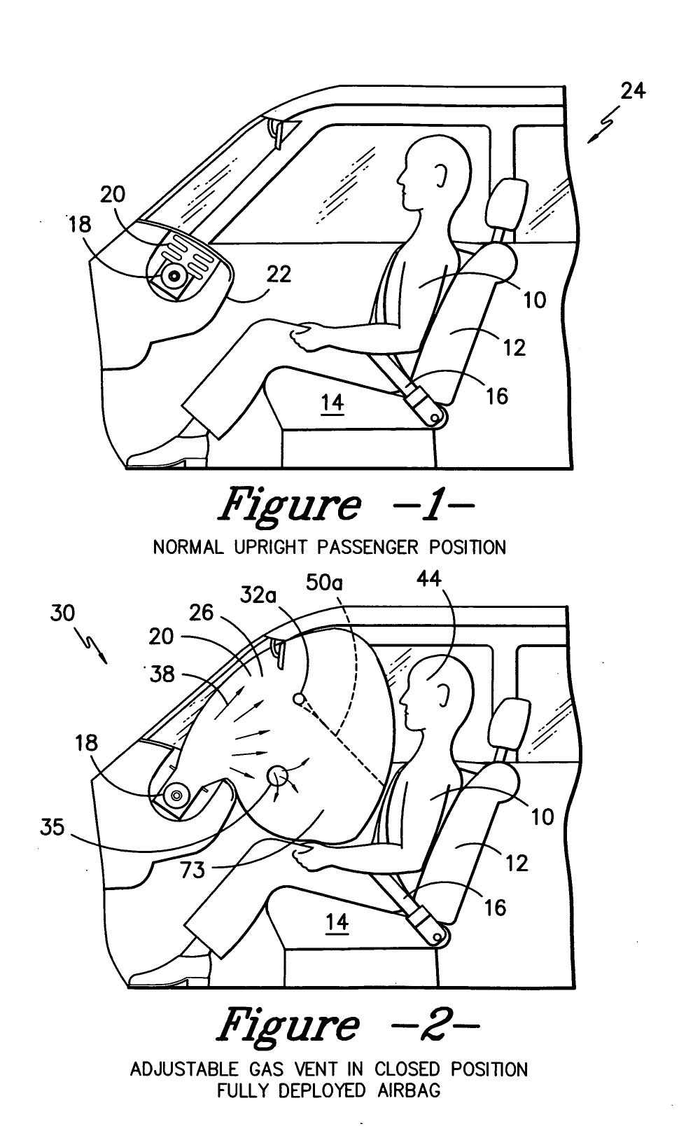

FIG. 1 shows a passenger in an upright seat-belted passenger position 24. Passenger 10 is restrained by seat belt 16 into seat back 12 and seat base 14. Inflation mechanism 18 is in the dashboard 22, and configured for operation with airbag 20. Sensors (not shown) detect a collision, and relay signals to the inflation mechanism 18, causing activation and release of gas 38.

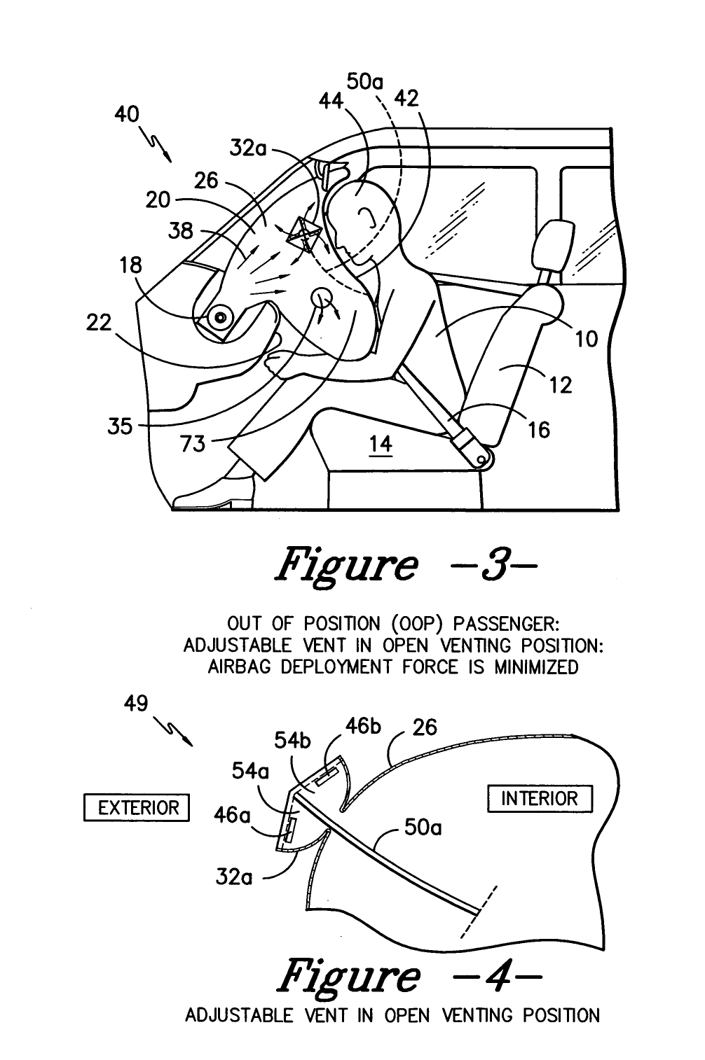

FIG. 2 illustrates a later time in deployment of the unobstructed airbag, in which the airbag has fully deployed following a collision. The airbag 20 is not obstructed during the initial phase of deployment, as further shown in FIG. 2, in which the primary inflatable enclosure 26 is fully advanced into the passenger compartment of the vehicle, due to release of gas 38 from the inflation mechanism 18. Central cavity 73 of the airbag 20 is shown.

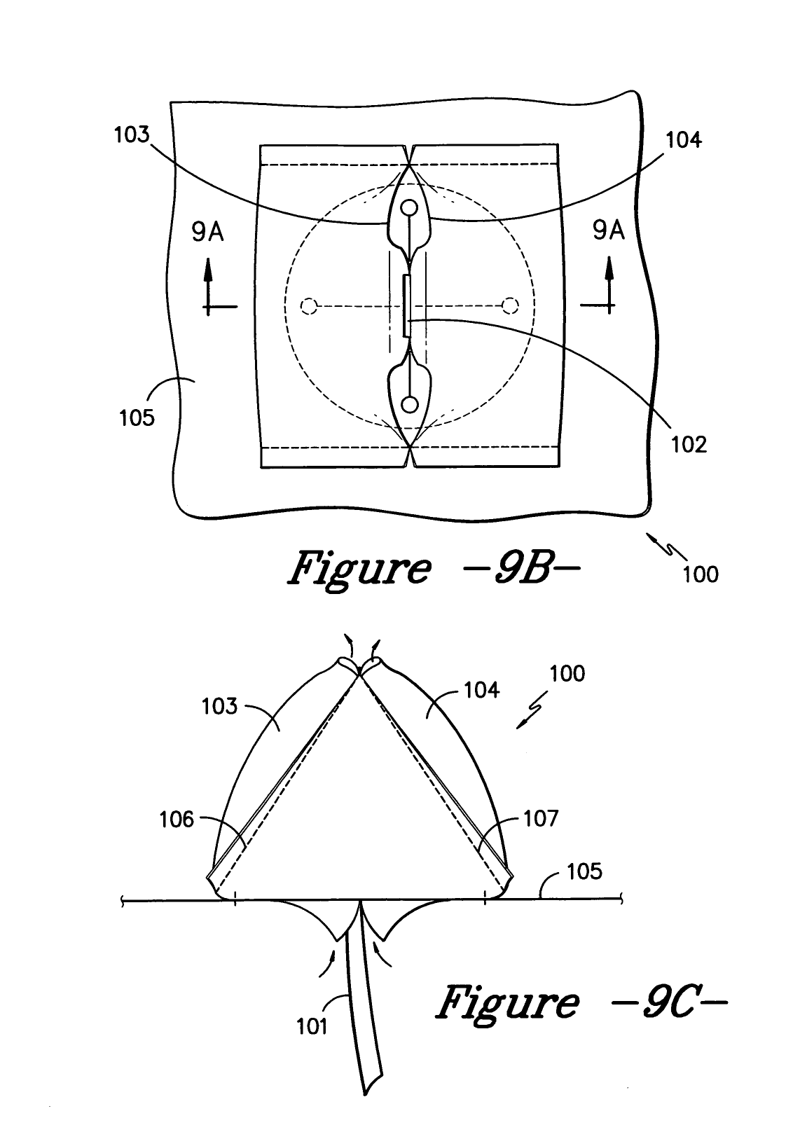

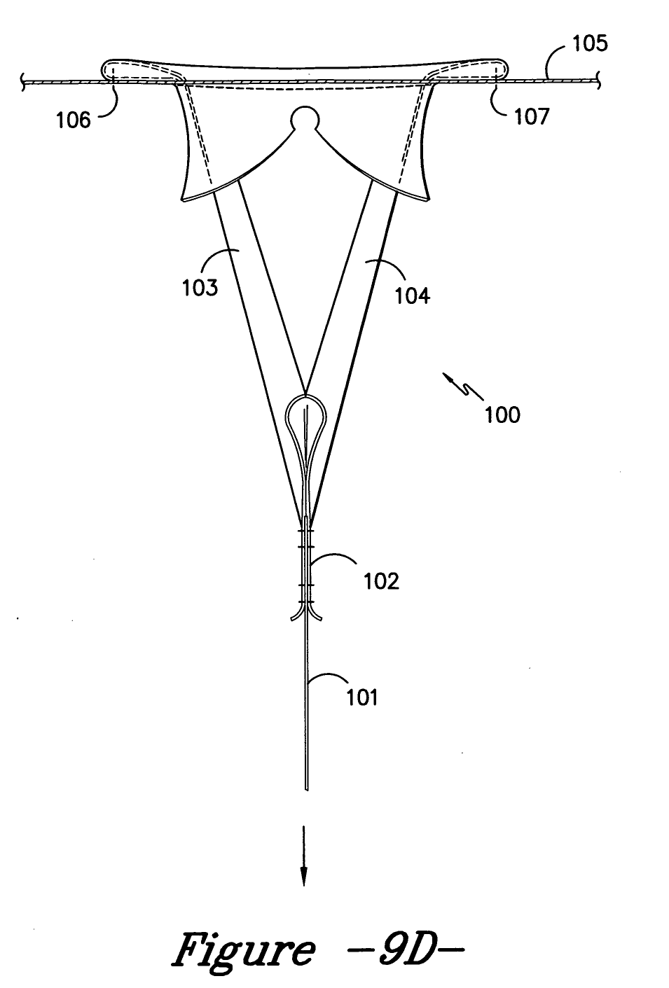

FIG. 2 shows a point in time just before the passenger has begun moving forward into the inflated airbag 20, when gas is emerging from standard (non-adjustable) vent 35. The inflatable gas vent 32a in this example has moved from an open venting position to a closed non-venting position, resulting in full force airbag deployment. This occurs by the airbag moving beyond the length of internal tether 50a (See FIGS. 7-8).

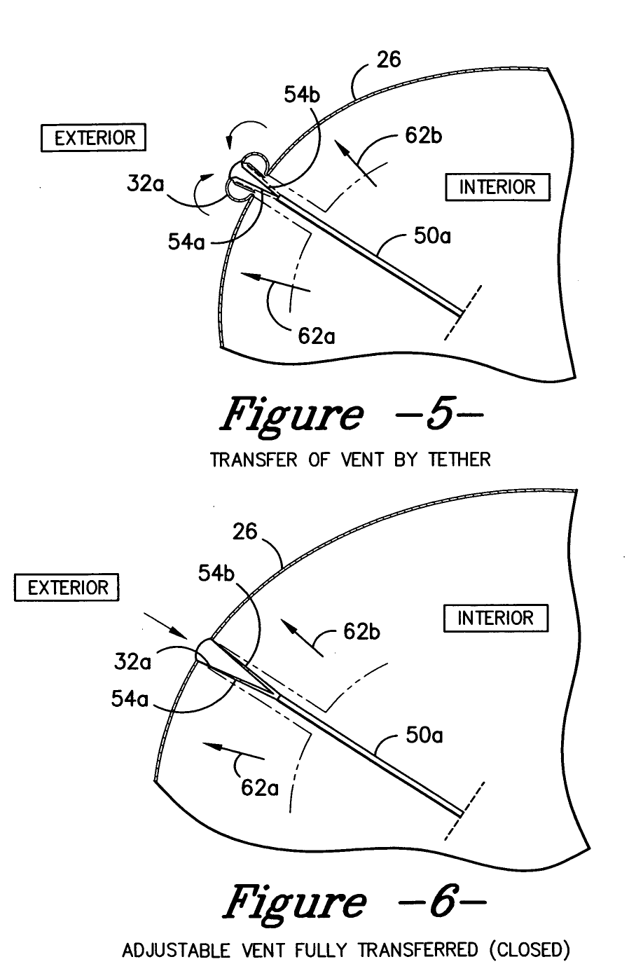

FIG. 3 represents a very different set of circumstances compared to FIGS. 1-2 and 7-8. In the example of FIG. 3, an obstruction of an out of position passenger 10 (OOP) has his or her upper body and head 44 undesirably near the dashboard or steering wheel at the time of collision.

This out of position passenger could occur for many reasons. For example, a passenger 10 could be leaning over and adjusting the radio (distracted) at the moment of impact. Alternately, the passenger 10 (if driving) could have become unconscious due to heart attack or other medical problem, slumping against the steering wheel or dashboard 22. The passenger could be trying to retrieve something located on the floor of the vehicle. In another instance, an extremely short passenger 10, with the seat base 14 pulled all the way forward in the automobile could be sitting too close to the dashboard 22. Another circumstance or example of this type is that an unbelted child may be hovering near or upon the dashboard 22 at the moment of collision. There are many possibilities for an OOP passenger situation. In general, FIG. 3 illustrates the situation in which a passenger 10 for whatever reason is located undesirably close to the airbag primary inflatable enclosure 26 at the moment of impact.

In FIG. 3, the inflation mechanism 18 is forcing gas into the primary inflatable enclosure 26 at a rapid rate, and the leading edge 42 is actually undesirably exploding into the head 44 of passenger 10. This could cause serious injury if the full amount of gas pressure from inflation mechanism 18 was not released outside the airbag before maximum deployment. This invention is designed to reduce the force of airbag impact in this out of position passenger circumstance, and the central cavity 73 will not enlarge to full size.

The manner of reducing the force of impact in the situation of FIG. 3 is described herein. Inflatable gas vent 32a is in the open venting position. The vent 32a is in the open position because the leading edge 42 has not moved as far as it would in normal unobstructed deployment. The effect of the inflatable gas vent 32a remaining open during deployment is to vent early in the deployment process a large additional amount of gas that otherwise would contribute to maximum deployment. This venting is in addition to the conventional venting that occurs through standard vent 35. It should be noted that in a typical embodiment of this invention, there are inflatable gas vents and also conventional standard vents on each side of the airbag (see FIGS. 7-8 herein). The net result is that large amounts of explosive gases are vented to the exterior side of the primary inflatable enclosure 26 of the airbag 20, which substantially reduces the force of impact. The added venting through inflatable gas vent 32a reduces substantially the force of impact upon passenger 10. That is, the leading edge 42 of airbag 20 impacts more softly into the head 44 of the out of position passenger 10, due to extra gas venting through adjustable gas vent 32a and 32b (seen in FIG. 8).

One advantage of this manner of reducing airbag force is that the mechanism of action is dynamically controlled. In this situation, the error rate of incorrect airbag deployment is reduced, since there are no electronic signals necessary to reduce in real time the force of impact in the out of position occupant situation. Any other mechanism (as in the prior art) that relies upon signals or sensing of electronic signals is inherently less reliable than a dynamic system of the invention.

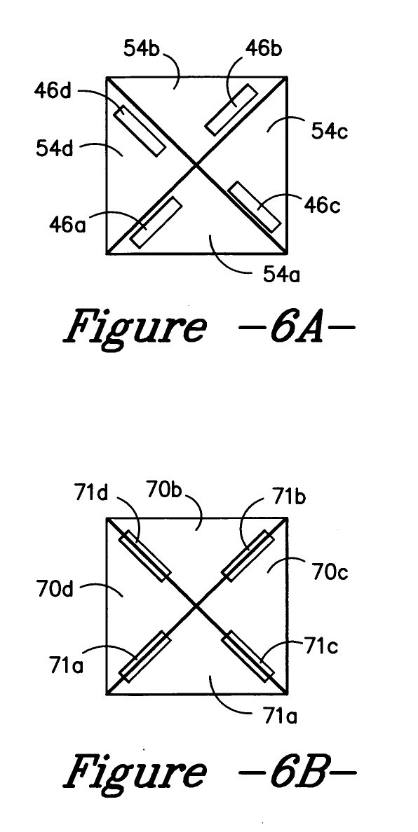

FIG. 4 shows a partial cross-section of an inflatable gas vent 32a of the invention in the open venting position. Tether 50a of a predetermined length is attached to inflatable gas vent 32a. Folds 54b and 54a are seen, which contain vent holes 46a and 46b.

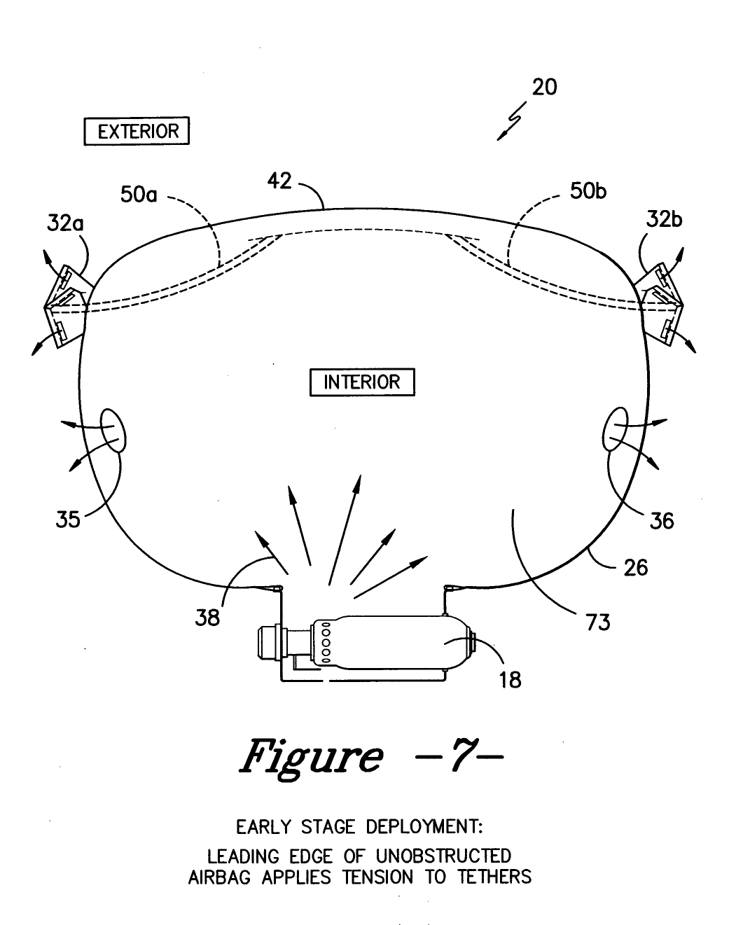

FIG. 5 reveals the transfer of an inflatable and transferable gas vent 32a (as in FIG. 4) from an open venting position to a closed non-venting position. This occurs by of the movement of the leading edge 42 beyond the range (length) of tether 50a, which results in the leading edge of the airbag primary inflatable enclosure 26 moving beyond the vent 32a, pulling the vent 32a from the exterior of the primary inflatable enclosure 26 to the interior.

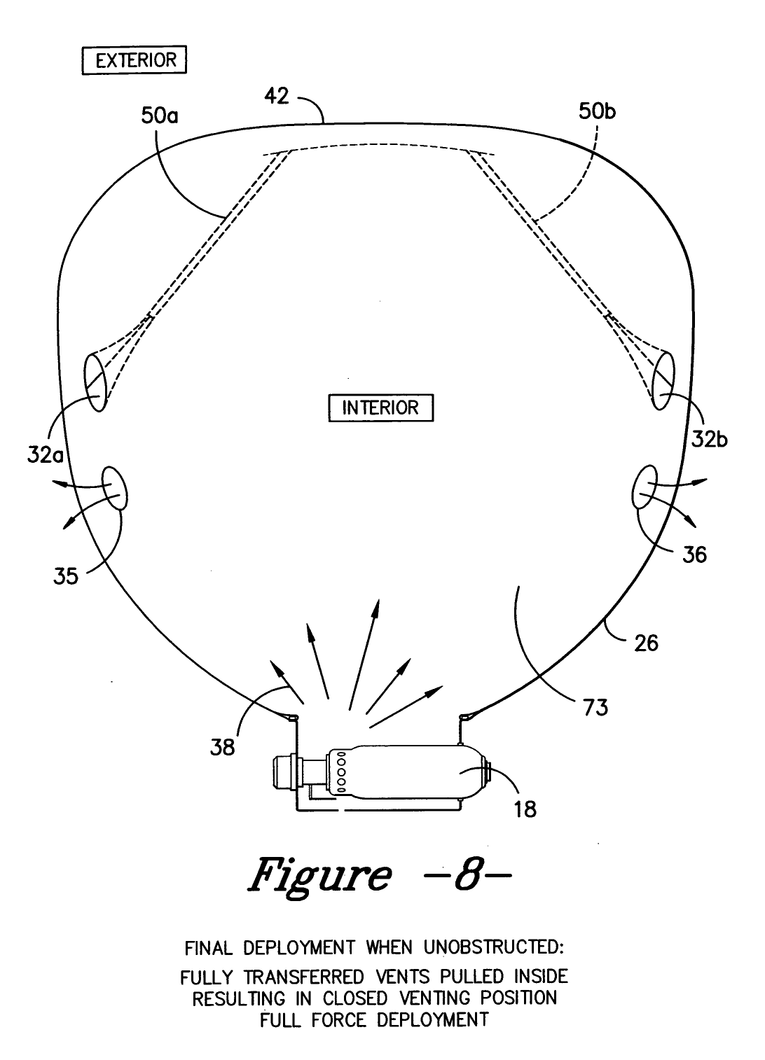

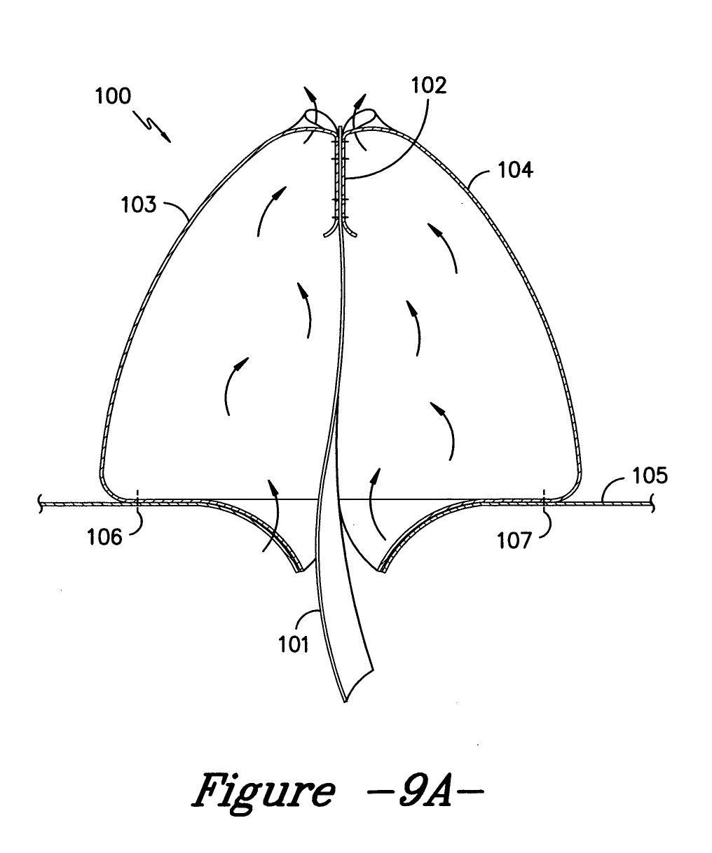

FIG. 6 illustrates the final stage of inflatable vent 32a transfer. This results in substantial closure of the inflatable gas vent 32a. FIG. 6A illustrates one potential embodiment of the adjustable gas vent 32a, in which folds 54a-d contain, respectively, vent holes 46a-d (See FIGS. 6A-6B). Although this embodiment shows a four fold arrangement, it is recognized that any number of such folds or sides could be employed, including two, three, and five, six, seven, eight, nine, ten, or more. Any geometry that works well in manufacturing operations could be employed to vent the gas. FIG. 6B shows another embodiment of the inflatable gas vent, in which folds 70a-d are separated by vent holes 71a-d, located between the folds.

FIG. 7 illustrates a top view of an early stage deployment similar to that shown in FIGS. 1-2, wherein the leading edge of the unobstructed airbag 20 is applying tension to the tethers 50a and 50b, which pulls on the inflatable gas vents 32a-b. In this deployment, there is no out of position occupant or passenger (similar to that shown in FIGS. 1-2). FIG. 8 shows the situation of FIG. 7 at a later point in time. Inflatable gas vents 32a-b are closed due to the advancement of leading edge 42 of airbag 20 beyond the inflatable gas vents 32a-b. Conventional airbag vents 35-36 are shown as well, which release gas from central cavity 73. This results in change in location of the inflatable gas vents 32a-b, from the exterior side to the interior side of the primary inflatable enclosure 26. This results in closure of the inflatable gas vents 32a-b, which eliminates gas escape from the inflatable gas vents 32a-b, which maximizes airbag force for the collision protection of the normally seated occupant.

FIG. 8 shows the situation of FIG. 7 at a later point in time, in which the tethers have pulled the gas vents from the exterior side to the interior side of the primary inflatable enclosure, resulting in closure of the gas vents.

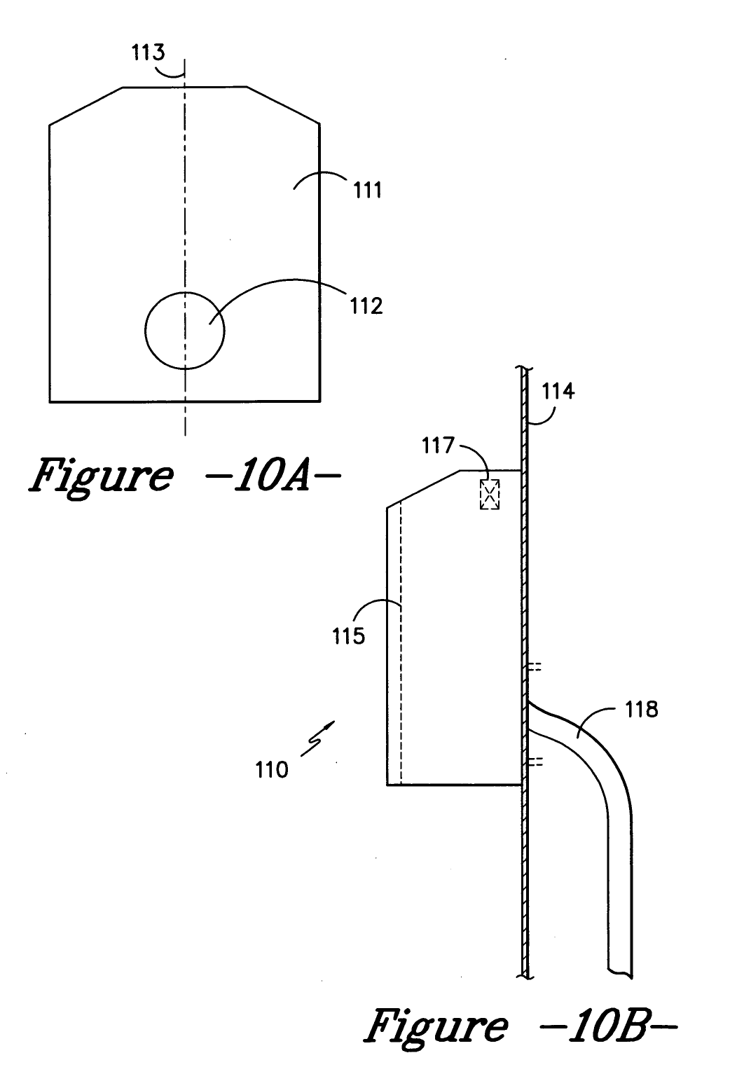

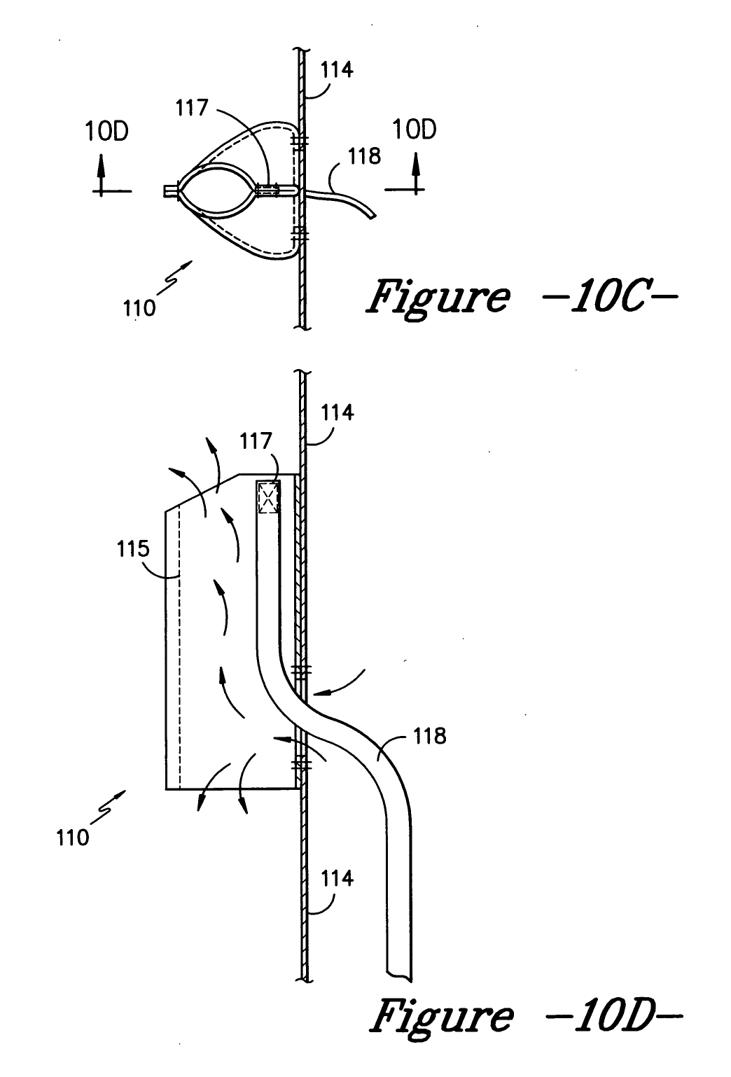

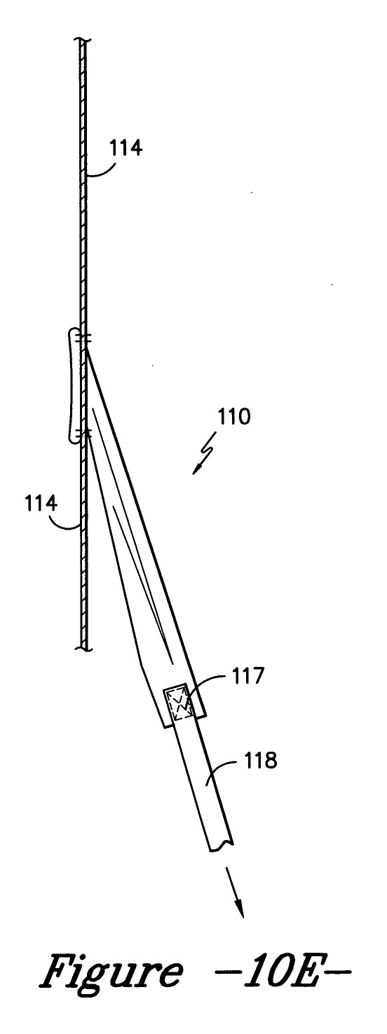

FIG. 9A (cross-sectional view along 9A-9A of FIG. 9B) reveals an alternate embodiment of the invention, with an alternate configuration for the venting structure, gas vent 100. Tether 101 is sewn or otherwise attached at tether attachment point 102 to the walls 103,104 of the gas vent 100. The gas vent 100 is attached to primary inflatable enclosure 105 at attachment points 106, 107. Inflation gases pass along the direction of the arrows during venting.

FIG. 9B is a top view of the device shown in FIG. 9A. FIG. 9C shows a perspective view of the gas vent 100 of FIGS. 9A-9B, showing seams 106 and 107. FIG. 9D shows the gas vent 100 in the pulled through and closed configuration.

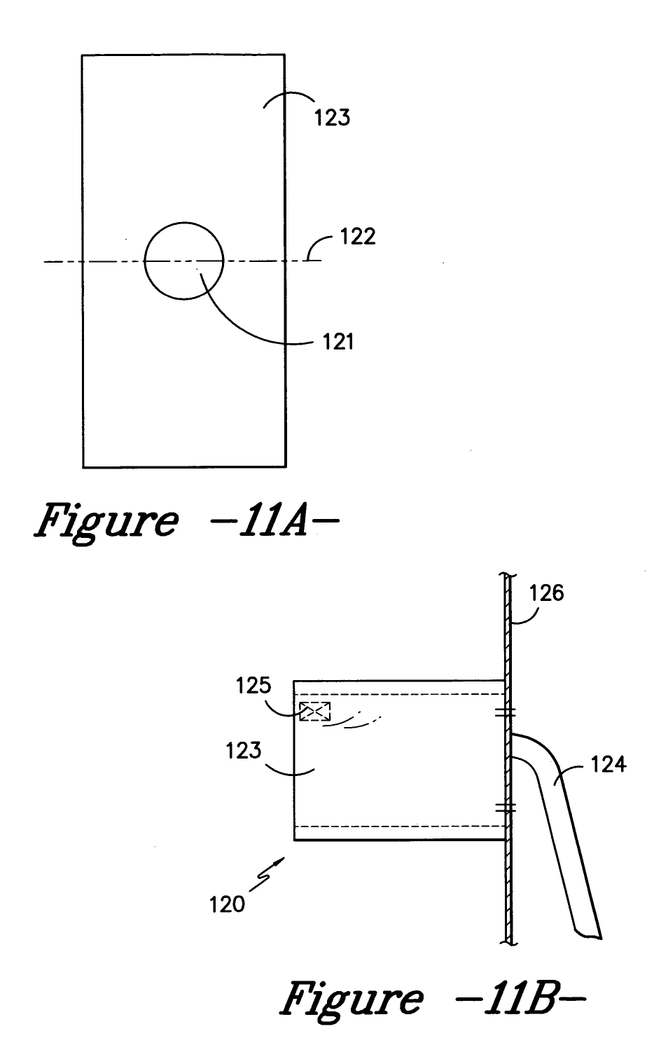

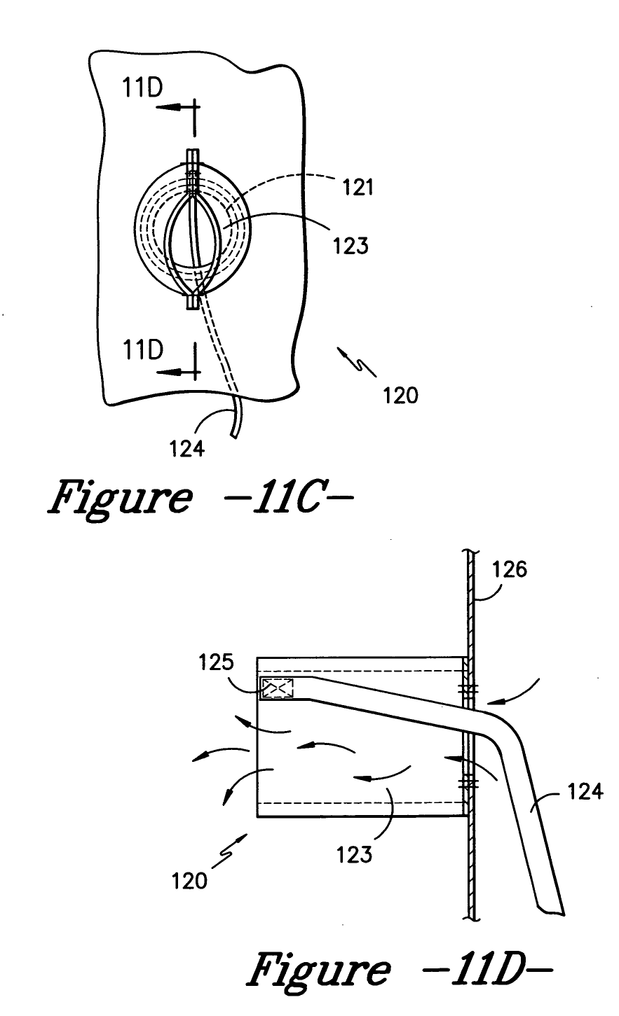

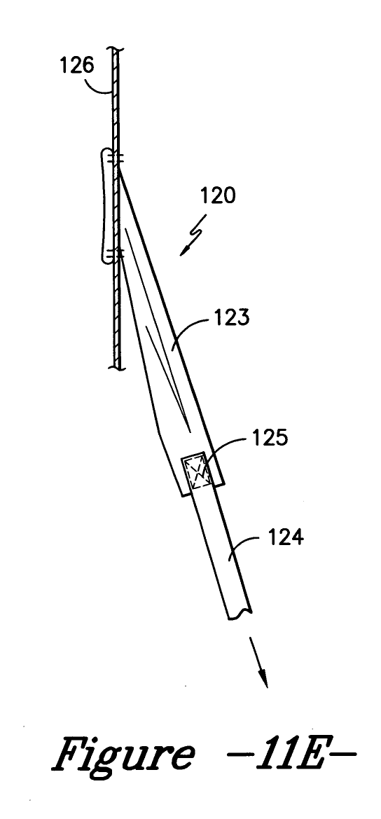

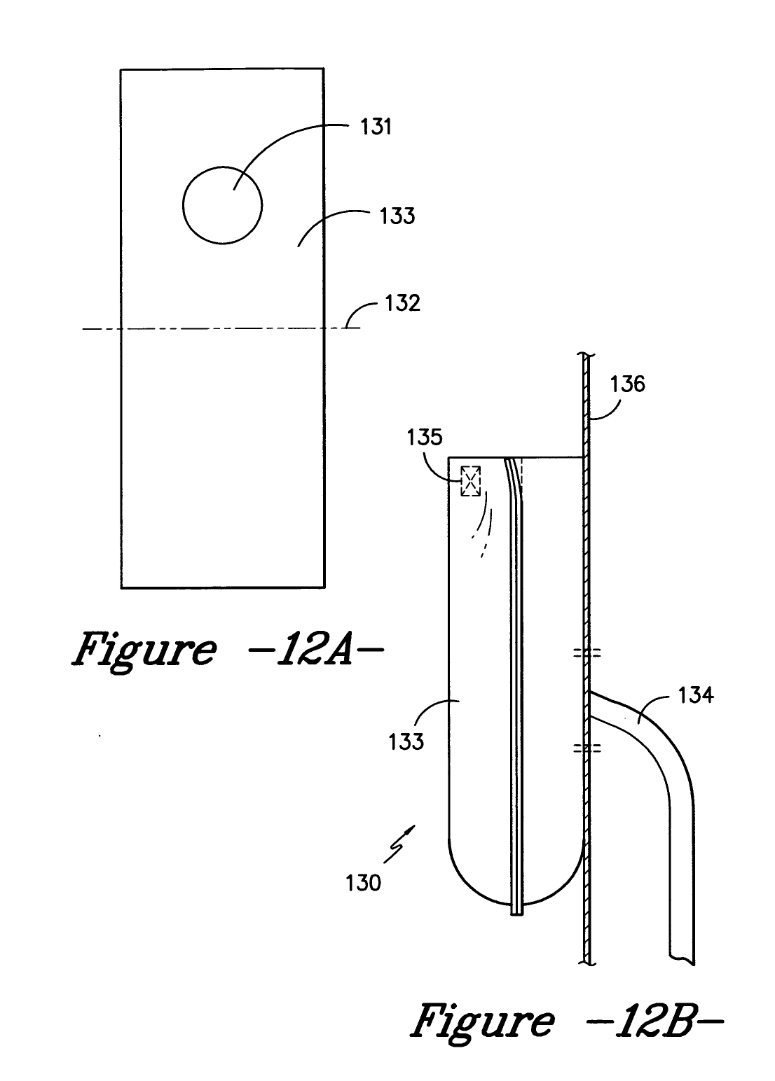

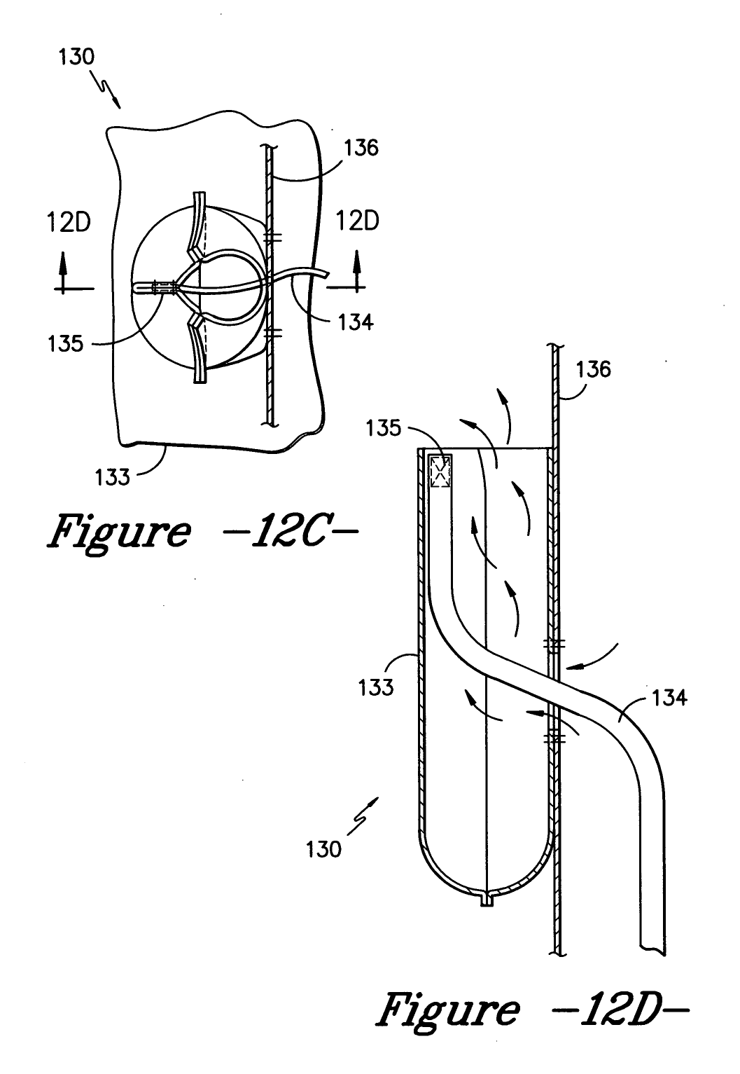

FIGS. 10A-10E show an alternate embodiment of a gas vent 110, constructed from blank 111. A hole 112 is shown with fold line 113. When the blank 111 is folded, it may be attached to airbag wall 114, and closed with stitches 115 to form vent 110. Tether 118 is sewn at point 117. FIG. 10C shows a top view looking down into the top of the vent 110. Air flows along the direction of arrows shown. FIG. 10D shows a cross sectional view taken along lines 10D-10D of FIG. 10C. FIG. 10E shows the vent 110 in the closed position, pulled through and beyond the airbag wall 114.

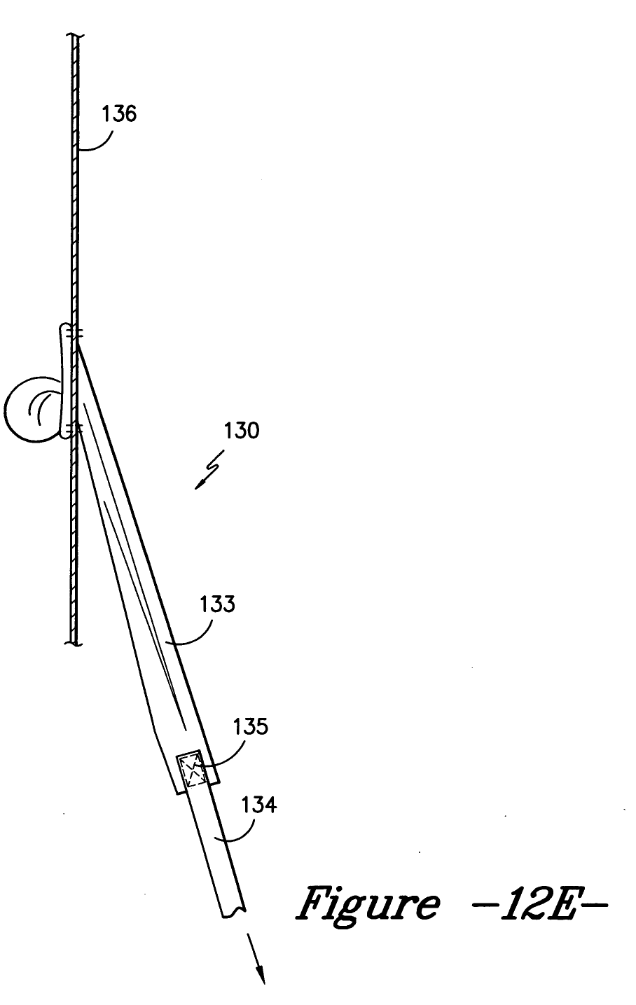

FIGS. 11A-E show an alternate and additional embodiment of a gas vent 120 made from blank 123. The blank 123 contains fold line 122, across whole 121. Tether 124 is stitched to blank 123 at point 125. Blank 124 is stitched to airbag side wall 126. FIG. 11E shows the closed position of gas vent 120, which is pulled beyond the side wall 126.

FIGS. 12A-E show an alternate and additional embodiment of a gas vent 130 made from blank 133. The blank 133 contains fold line 132, across whole 131. Tether 134 is stitched to blank 133 at point 135. FIG. 12D shows a cross sectional view taken along lines 12D-12D shown in FIG. 12C. Blank 134 is stitched to airbag side wall 136. FIG. 12E shows the closed position of gas vent 130.

The invention is further shown and described by the appended claims.

1. An inflatable passenger restraint airbag having a transferable and inflatable gas vent, the airbag comprising a primary inflatable enclosure having an interior side and an exterior side and at least one gas vent connected to the primary inflatable enclosure, the gas vent being transferable between an open venting position and a closed non-venting position, the airbag further comprising a tether which is at least partially located on the interior side of the primary inflatable enclosure, the tether being connected to the inflatable gas vent.

2. The airbag of claim 1 wherein the tether is configured for facilitating the transfer of the gas vent from an open venting position to a closed non-venting position.

3. The airbag of claim 1 wherein the vent in the open venting position is positioned substantially on the exterior side of the primary inflatable enclosure.

4. The airbag of claim 1 wherein the airbag is provided with two transferable gas vents.

5. The airbag of claim 1 wherein the vent in the closed non-venting position is positioned substantially on the interior side of the primary inflatable enclosure.

6. A system for adjusting the force of airbag deployment in real time, the system comprising:
(a) an inflation mechanism capable of producing inflation gas,
(b) a primary inflatable enclosure, the primary inflatable enclosure having an interior side and an exterior side, the primary inflatable enclosure having a mouth opening and a central cavity, the primary inflatable enclosure being connected to the inflation mechanism at the mouth opening;
(c) at least one gas vent connected to the primary inflatable enclosure, the gas vent being transferable between:
i) an open venting position, and
ii) a closed non-venting position,
(d) a tether, the tether being at least partially located within the central cavity of the primary inflatable enclosure, the tether being connected both to the vent and also to the inflatable enclosure, and
(e) wherein, upon activation of the inflation mechanism, the amount of inflation of the primary inflatable enclosure depends upon the displacement of the leading edge of the primary inflatable enclosure during inflation.

7. The system of claim 6, wherein maximum inflation of the primary inflation enclosure is facilitated by movement of the gas vent from an open venting position to a closed non-venting position, said movement being facilitated by tension applied to the tether.

8. The system of claim 6 in which, during activation of the inflation mechanism, an out of position passenger in undesirable close proximity to the primary inflatable enclosure is contacted by the primary inflatable enclosure at an early stage of inflation, such contact resulting in maintenance of the gas vent in the open venting position during the inflation event, thereby reducing the volume of gas in the primary inflatable enclosure by gas venting through the gas vent during the inflation event, wherein the force of deployment of the primary inflatable enclosure upon the passenger is reduced.

9. A method for deploying an airbag against a seat occupant, the method comprising:
(a) providing an inflation mechanism capable of producing inflation gas,
(b) providing a primary inflatable enclosure having an interior side and an exterior side, the primary inflatable enclosure having a mouth opening and a central cavity on the interior side, the primary inflatable enclosure being connected to the inflation mechanism at the mouth opening;
(c) providing at least one gas vent, the gas vent being transferable between:
i) an open venting position, and
ii) a closed non-venting position;
(d) providing a tether, the tether being at least partially located within the central cavity of the primary inflatable enclosure, the tether being connected to the gas vent and to the inflatable enclosure and configured for transfer of the gas vent;
(d) activating the inflation mechanism, thereby forcing gas into the primary inflatable enclosure;
(e) rapidly advancing the primary inflatable enclosure, whereby:
(i) if the primary inflatable enclosure encounters an out of position seat occupant, then advancement of the tether is inhibited, thereby failing to transfer the gas vent so that the gas vent remains in the open venting position, thereby minimizing the force of deployment of the airbag against an out of position seat occupant; and, alternatively,
(ii) if the primary inflatable enclosure does not encounter an out of position seat occupant, then advancement of the tether is uninhibited, thereby transferring the gas vent to a closed non-venting position located substantially on the interior side of the enclosure, thereby maximizing the deployment of the airbag against a seat occupant.

10. The method of claim 9 in which, in the event of step (e)(ii), the tether applies a tension force to the gas vent, thereby transferring the vent to the closed non-venting position.

11. An inflatable passenger restraint airbag having at least one inflatable and transferable gas vent that can be transferred from outside of the airbag in an open position to inside of the airbag in a closed position, wherein the vent is adapted for becoming part of the tethering mechanism in some instances, depending upon the inflated state of the airbag.

12. The airbag of claim 11, said airbag having a variable venting rate depending on the open or closed position of the inflatable vent.

13. The airbag of claim 11 wherein the vent in the open venting position is positioned substantially on the exterior side of the primary inflatable enclosure.

14. The airbag of claim 11 wherein the airbag is provided with a second transferable gas vent.

15. The airbag of claim 11 wherein the vent in the closed position is positioned substantially on the interior side of the primary inflatable enclosure.
